(19) United States
(12) Patent Application Publication
(10) Pub. No.: US 2020/0383314 A1
(43) Pub. Date: Dec. 10, 2020

(54) TREESTAND WITH CABLE RETENTION SYSTEM

(71) Applicant: Anthony D. Overbaugh, Winchester, VA (US)

(72) Inventor: Anthony D. Overbaugh, Winchester, VA (US)

(21) Appl. No.: 16/806,563

(22) Filed: Mar. 2, 2020

Related U.S. Application Data
(60) Provisional application No. 62/857,168, filed on Jun. 4, 2019.

(51) Int. Cl. A01M 31/02

(52) U.S. Cl. CPC A01M 31/02

(57) ABSTRACT

A treestand has a ladder and platform. A grip formed on an edge of the platform contacts a tree and a first end of a retention strap is fixedly attached to one side of the platform. A pull rope attaches to a second end of the retention cable and pulls the retention cable through a first guide and a second guide so that the send end of the retention cable can be secured, such as to the ladder. The first guide and second guide ensure that the retention cable is in position to secure the platform to the tree and the tension on the retention cable maintains the retention cable in place.

### CROSS REFERENCE TO RELATED APPLICATIONS

This application claims benefit under 35 USC 119(e) to provisional application 62/857,168, filed Jun. 4, 2019, the entire content of which are incorporated herein by reference.

### BACKGROUND OF THE INVENTION

Treestands are often used in hunting, particularly bow hunting. Typically, the treestand has a ladder extending upward to a platform that is secured to the tree. The elevated position of the platform allows errant shots to quickly hit the ground without travelling far, increasing safety. The platform must be comfortable and securely attached to a tree to enable a person to remain on the platform for an extended period of time, often including movement by the person.

It is an object of the invention to provide a treestand that can be secured at an elevated point of a tree by a person on the ground.

It is another object of the invention to provide a treestand that securely attaches to a tree.

It is yet another object of the invention to provide a treestand that is portable and easy to assemble.

These and other objects of the invention will be apparent to one of ordinary skill in the art after reading the disclosure of the invention.

### SUMMARY OF THE INVENTION

A treestand has a ladder and platform. A grip formed on an edge of the platform contacts a tree and a first end of a retention strap is fixedly attached to one side of the platform. A pull rope attaches to a second end of the retention cable and pulls the retention cable through a first guide and a second guide so that the send end of the retention cable can be secured, such as to the ladder. The first guide and second guide ensure that the retention cable is in position to secure the platform to the tree and the tension on the retention cable maintains the retention cable in place.

After the ladder and platform are placed against the tree, the retention cable extends downwardly from the fixed attachment point. The pull rope extends from the ground, through a first guide and second guide and back to the ground. One end of the pull rope is attached to the fee end of the retention cable and the pull rope is pulled through the guides, bring the retention cable through the guides. Thereafter, the pull rope can be detached from the retention cable and the retention cable secured to the ladder to create and maintain tension in the retention cable. In the manner, the retention cable secures the treestand to the tree.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a perspective view of the treestand attached to a tree;

FIG. 2 is a detailed view of the platform and retention cable;

FIG. 3 is a detailed view of the platform and retention cable with the retention cable in place;

FIG. 4 is a detailed view of the edge of the platform when the retention cable is secured in place; and

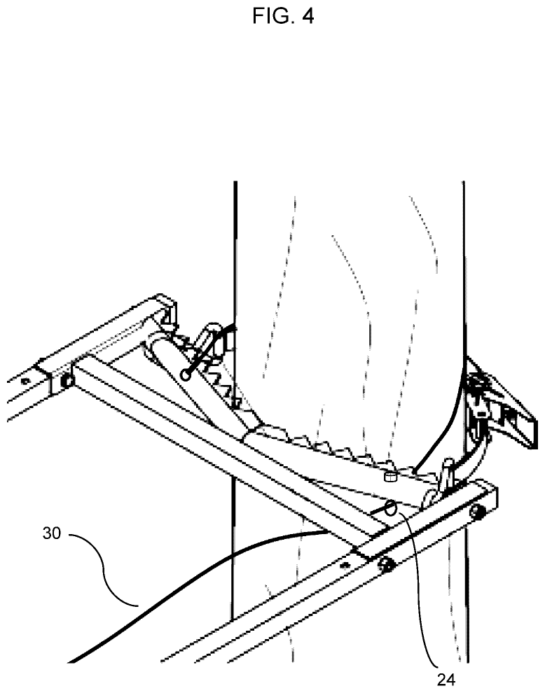

FIG. 5 is an exploded view of the ladder and braces.

### DETAILED DESCRIPTION OF THE INVENTION

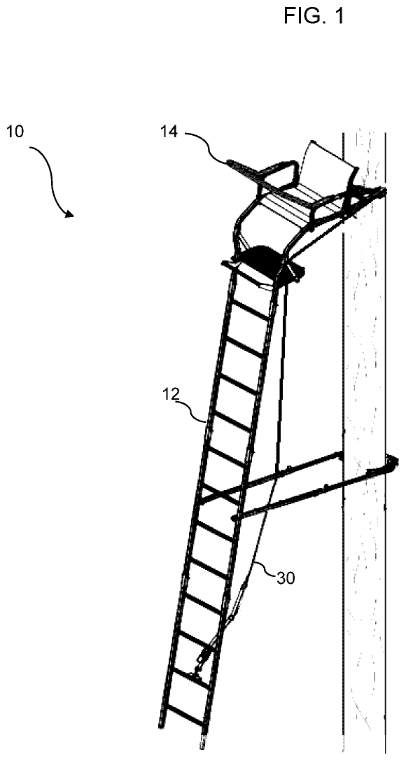

The treestand 10 includes a ladder 12 and a platform 14, as seen in FIG. 1. The ladder is formed in sections that can be connected to reach sufficient heights for hunting but separable to be in lengths which allow transportation into woods to a desired location. The ladder sections are attached to one another by any suitable means, such as the end of one section fitting into the end of an adjacent section in a telescoping manner. The ladder also includes braces, which will be discussed in more detail later.

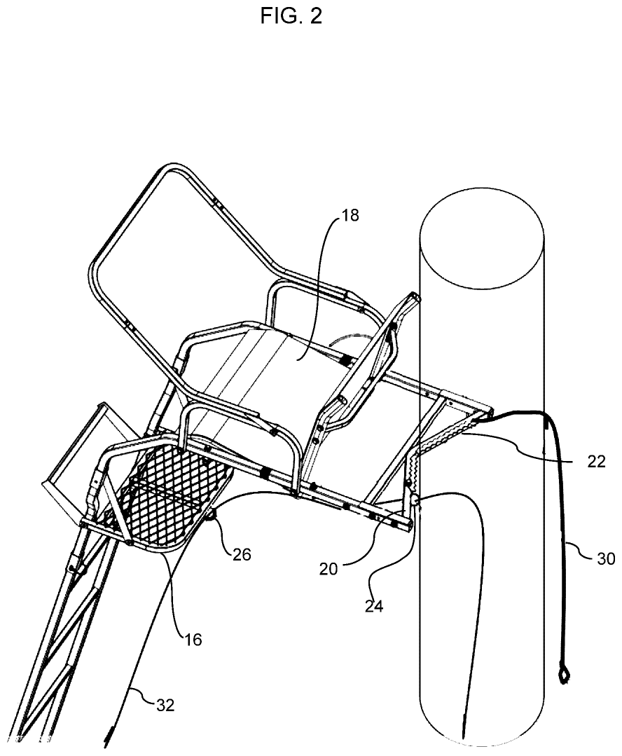

The platform 14 extends outwardly from the top of the assembled ladder. The platform supports the user and can take many different forms. The platform of FIG. 2 has a base 16 and seat 18. The base provides a foot rest when the user is seated in the seat. The seat has a frame with a front edge 20 and a gripping surface 22. The gripping surface may be incorporated into the front edge or be separate from the front edge. The gripping surface of FIG. 2 has a shallow V-shape to create greater contact area between the gripping surface and tree. Typically, the gripping surface will contact the tree at two spaced apart locations on either side of a center of the gripping surface.

A retention cable 30 connects to the platform. As seen in FIG. 2, one end of the retention cable is fixedly attached to a first side of the gripping surface 22. The first end may be removable attached to the platform for ease of transporting and storage but when attached, the first end does not move relative to the platform. As seen in FIG. 2, the retention cable 30 has a length to enable the retention cable to extend down to near ground level. To secure the retention cable to the tree and thereby secure the platform to the tree, a pull rope attaches to the send end of the retention cable. The pull rope extends upwardly from the second end of the retention cable, through a first guide 24 on the seat, a second guide 26 on the base and downwardly toward the ground.

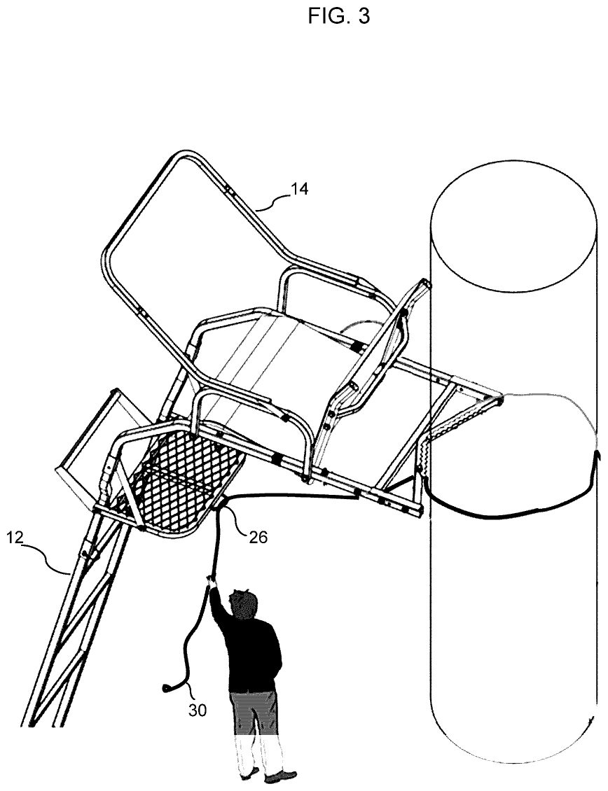

As seen in FIG. 3, pulling on the pull rope causes the retention cable to pass through the first guide 24 and second guide 26 to bring the second end of the retention cable in proximity to the ladder. The retention cable can then be attached to the ladder to create and maintain tension in the retention cable. The first guide 24 allows the retention cable to continue in a mainly horizontal direction with a maximum length of contact with the tree to maintain the cable in place about the tree when tension is applied to the cable. The second guide 26 on the seat allows the pulling rope and retention cable to change direction and extend toward the ground, where it can be accessed by the user. The cable extends downwardly from the second guide, enabling the downward tension in the retention cable to maintain the cable in place around the tree and help secure sections of the ladder together when the retention cable is attached to the lowermost section of the ladder. The retention cable can be attached to the rung of the ladder to create tension.

The retention cable is preferably a steel cable having a circular cross section. A nylon strap or other similar device can be used as the retention cable, but a steel cable has been found to work best, as the steel cable provides sufficient strength and travels smoothly up the tree as it is being pulled by the pull rope. The length of the retention cable needs to be sufficient to encircle the tree and be able to be attached to an anchor point, such as the ladder, by a user on ground level. Therefore, the retention cable should be longer than the height of the ladder. The first guide can be an eyelet attached to the gripping surface 22 or an aperture passing through the gripping surface, as long as the retention cable is able to move relative to and pass through the first guide. The second guide can be on the seat or ladder instead of the base.

It is possible to attach the retention cable to the tree without the use of a pull rope. However, this would require having the retention cable encircle the tree, passing the retention cable through the first guide and second guide while the platform is near ground level and then raising the platform into place against the tree. The retention cable than would need to be much longer than otherwise needed, making attachment of the cable to create tension more difficult. By having the pull rope pass through the first guide and second guide before the platform is raised and then being able to attach the pull rope to the retention cable greatly simplifies the process of installing the treestand.

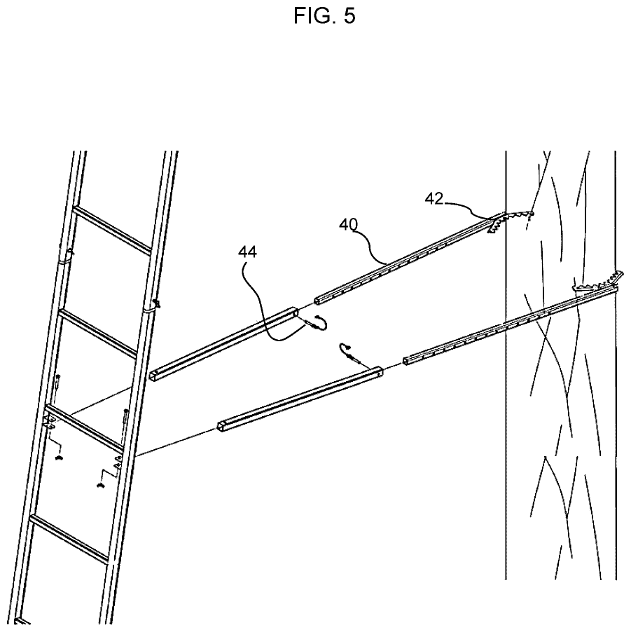

FIG. 5 depicts braces 40 attached to the ladder to improve the stability of the treestand. The braces 40 are pivotally and detachably connected to the ladder. The braces include telescoping sections to allow the adjustment of the lengths of the braces to engage the tree. The ends of the braces are provided with gripping surfaces 42 similar to the gripping surface of the platform. A strap 44 may be used to bias the braces toward one another to increase the stability of the treestand.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

I claim:

1. A treestand, comprising:
a ladder having a plurality of rungs;
a platform extending outwardly from an upper end of the ladder;
a gripping surface at a front edge of the platform;
a retention cable fixedly attached to a first side of the platform;
a first guide on the platform, the first guide allowing for passage of the retention cable; and
a second guide attached to the platform, the second guide allowing for passage of the retention cable.

2. The treestand of claim 1, wherein the gripping surface is V-shaped.

3. The treestand of claim 1, further comprising a pull rope detachably connected to the retention cable.

4. The treestand of claim 1, further comprising braces attached to and extending from the ladder at a position between a lower end and the upper end of the ladder.

5. The treestand of claim 1, wherein the platform includes a base and a seat,
wherein the first guide is attached to the seat, and
wherein the second guide is attached to the base.

6. The treestand of claim 1, wherein the first guide is on a second side of the platform

7. A method of securing a treestand to a tree, comprising:
passing a pull rope through a first guide on a platform attached to an upper end of a ladder;
raising the ladder upward and bracing a front edge of the platform against a tree;
connecting the pull rope to a second end of a retention cable attached to a first side of the platform;
pulling the retention cable through the first guide by pulling the pull rope through the first guide;
applying tension to the retention cable.

8. The method of claim 7, further comprising passing the pull rope through a second guide; and
pulling the retention cable through the second guide by pulling the pull rope through the second guide after the pull rope is pulled through the first guide.

9. The method of claim 7, further comprising attaching the retention cable to the ladder to apply tension to the retention cable.

10. The method of claim 9, further comprising attaching the retention cable to the ladder with a ratchet strap.
